(19) United States
(12) Patent Application Publication
(10) Pub. No.: US 2008/0199148 A1
(43) Pub. Date: Aug. 21, 2008

(54) INFORMATION RECORDING AND REPRODUCING DEVICE

(76) Inventor: Chikashi HAYASHI, Osaka (JP)

Correspondence Address: MCDERMOTT WILL & EMERY LLP, 600 13TH STREET, NW, WASHINGTON, DC, 20005-3096, US

(21) Appl. No.: 12/032,486

(22) Filed: Feb. 15, 2008

(30) Foreign Application Priority Data
Feb. 15, 2007 (JP) 2007-034449

(51) Int. Cl. H04N 5/91; H04N 5/85; H04N 5/907

(52) U.S. Cl. 386/68; 386/E05.067; 386/E05.064

(57) ABSTRACT

A skipping unit performs a skipping process of skip reading information when reading out and reproducing the information from a recording medium. A reproducing section list generator generates and records a reproducing section list, which is a section list of a reproduction process of reading out and reproducing the information. A skipping section list generator generates and records a skipping section list, which is a section list of the skipping process in which the skipping unit skip reads the information over a period greater than or equal to a predetermined period when reading out the information. The reproducing section list generator deletes a skipping section from the reproducing section every time the skipping unit performs the skipping process over a period greater than or equal to the predetermined time, and the skipping section list generator creates a skipping section list including the skipping section deleted from the reproducing section list.

### BACKGROUND OF THE INVENTION

1. Field of the Invention

The present invention relates to a technique of reproducing and editing a randomly accessible information recording and reproducing device.

2. Description of the Related Art

In the information recording and reproducing device capable of recording and reproducing/editing information such as image and voice, a location where reproduction is not desired can be skipped by using a constant time skipping such as a thirty seconds skipping etc. during the reproduction of information (see e.g., Japanese Laid-Open Patent No. 2002-223408). The same location can be skipped every time the reproduction is carried out by carrying out editing of specifying reproduction starting point/reproduction ending point and deleting recorded data (see e.g., US2003/0215222).

In such techniques, however, when desiring to skip the same location, it is troublesome in that
the operation of the constant time skipping process must be carried out every time; and
editing task of specifying reproduction starting point/reproduction ending point and deleting recorded data must be performed.

As a countermeasure, the applicant has already made one proposal as disclosed in US2006/0188218. The information recording and reproducing device related to the conventional art includes a reproducing section list read-out unit, a constant time skipping unit, and a reproducing section list changing unit, where when the user performs the constant time skipping once, the reproducing section list is automatically changed based on the skip information at the relevant time. Since the reproducing section list is automatically updated when the constant time skipping is performed once, reproduction can be carried out while skipping the location where reproduction is unnecessary in the subsequent reproduction without performing the troublesome operation. Therefore, the trouble of the editing task of specifying reproduction starting point/reproduction ending point and deleting recorded data is resolved.

In the case of the information recording and reproducing device of the conventional art, however, the changed content of the reproducing section list that is automatically performed is difficult for the user to understand.

### SUMMARY OF THE INVENTION

It is a main object of the present invention to enable the user to easily check the changed content of the reproducing section list that is automatically performed.

(1) An information recording and reproducing device according to the present invention relates to an information recording and reproducing device including a skipping unit for performing a skipping process of skip reading information when reading out and reproducing the information from a recording medium; a reproducing section list generator for generating and recording a reproducing section list, which is a section list of a reproduction process of reading out and reproducing the information; and a skipping section list generator for generating and recording a skipping section list, which is a section list of the skipping process in which the skipping unit skip reads the information over a period greater than or equal to a predetermined period when reading out the information; wherein the reproducing section list generator deletes a skipping section from the reproducing section every time the skipping unit performs the skipping process over a period greater than or equal to the predetermined period; and the skipping section list generator creates a skipping section list including the skipping section deleted from the reproducing section list.

In such configuration, when the skipping process is performed during the read-out and reproduction of the information, the reproducing section list generator makes a change including deletion of the skipping section (from skip starting point to skip ending point) in the reproducing section list, and the skipping section list generator changes the skipping section list. In this case, a new skipping section list is created if the skipping section list is not yet created.

As a result, the user can carry out reproduction while automatically skipping the location to be skipped without particularly performing the editing task in the subsequent information reproduction. A skipping section list is provided apart from the reproducing section list, and the skipping section is updated as necessary in the skipping section list, whereby the user can easily check the section of the skipping process deleted from the reproducing section list.

(2) The information recording and reproducing device of the present invention has an aspect, in the above (1), where when a continuous skipping process in which a pair of skipping processes adjacent on a time axis is continuously performed within a predetermined interval section, the reproducing section list generator deletes the combined skipping section from the starting point of the preceding process to the ending point of the following process of the pair of skipping processes from the reproducing section in the reproducing section list; and the skipping section list generator creates the skipping section in the skipping section list including the combined skipping section.

According to such aspect, when a continuous skipping process in which a pair of skipping processes adjacent on a time axis is continuously performed within a predetermined interval section is performed, the combined skipping period is considered as one skipping process. That is, three sections of the skipping section of the first time, the skipping section of the second time, and the sandwiched section between such skipping sections are combined and considered as one skipping section, that is, a continuous skipping process.

If the sandwiched section is shorter than the interval section, the sandwiched section is considered to have a high probability of corresponding to the information the user actually does not want to reproduce. The sandwiched section is thus included as the target to be deleted from the reproducing section list or the target to be registered to the skipping section list.

In this case, the sandwiched section is also considered as the skipping section, and deleted from the reproducing section list and registered to the skipping section list, so that response similar to the (1) can be made even in the case of the continuous skipping process, whereby the trouble of operation can be resolved and the user can easily check the section at which the continuous skipping process is to be performed.

(3) The information recording and reproducing device of the present invention has an aspect, in the above (1), where when an opposite-direction skipping process is performed as the skipping process and an ending point of the opposite-direction skipping process is contained in the skipping section in the reproducing section list; the reproducing section list generator includes an opposite-direction skipping section in the reproducing section in the reproducing section list; and the skipping section list generator deletes the opposite-direction skipping section from the skipping section in the skipping section list.

In the opposite-direction skipping process, the opposite-direction skip ending point is on the upstream side of the opposite-direction skip starting point in a forward direction, and is in a converse relation with the normal skipping process (in the normal skipping process, the skip ending point is on the downstream side of the skip starting point). The opposite-direction skipping process is often operated when the user notices that the desired information has jumped at the early stage of the start of reproduction of a certain reproducing section. Therefore, when the opposite-direction skipping process is performed, the process jumps to the skipping location on the front side of the reproducing section.

According to such aspect, since the section at which the constant time skipping process is performed in an opposite direction is also the information the user actually wants to reproduce, the opposite-direction skipping section is included in the reproducing section. Thus, the opposite-direction skipping section returned to the reproducing section is deleted from the skipping section list to avoid the inconsistency described above.

(4) The information recording and reproducing device of the present invention has an aspect, in the above (1), where the skipping section list generator copies the skipping section list, and changes either the original or the copy of the skipping section list.

According to such aspect, the skipping section list that the user has intentionally edited is prevented from being changed against the intention of the user (ensure backup).

(5) The information recording and reproducing device of the present invention has an aspect, in the above (2), where the reproducing section list generator and the skipping section list generator set the interval section constant irrespective of change in length of the skipping process. According to such aspect, the configuration for realizing the present invention is simplified.

(6) The information recording and reproducing device of the present invention has an aspect, in the above (5), where the reproducing section list generator and the skipping section list generator set a plurality of interval sections different from each other, each interval section being constant irrespective of a change in length of the skipping process; and

the reproducing section list generator and the skipping section list generator can set an arbitrary interval section selected from among the plurality of interval sections. According to such aspect, control suited to the feeling of the user can be realized.

(7) The information recording and reproducing device of the present invention has an aspect, in the above (2), where the reproducing section list generator and the skipping section list generator set an interval section having correlation with the skipping process as the interval section. According to such aspect, the control closer to the feeling of the user at different times of skipping can be realized.

(8) The information recording and reproducing device of the present invention has an aspect, in the above (7), where the interval section is a linear function of the skipping process. According to such aspect, the control closer to the feeling of the user at different times of skipping can be easily realized.

(9) The information recording and reproducing device of the present invention has an aspect, in the above (8), where a slope and a Y intercept of the linear function can be arbitrarily set. According to such aspect, the control closer to the feeling of the user who has carried out skipping can be more easily realized.

(10) The information recording and reproducing device of the present invention has an aspect, in the above (7), where the interval section is a linear function of the skipping process, and has a lower limit value and an upper limit value. According to such aspect, by providing an upper limit of the linear function, it is avidable that a next skipping process after the performance of an extremely long skipping process is determined as a continuous skipping process despite the fact that the next skipping process is actually irrelevant to the extremely long skipping process. The skipping process immediately after performing an extremely short constant time skipping process can be determined as continuous as intended by the user by providing a lower limit of the linear function.

(11) The information recording and reproducing device of the present invention has an aspect, in the above (7), where the interval section is a linear function of the skipping process, and a slope and a Y intercept of the linear function vary according to process time of the skipping process. According to such aspect, the control closer to the feeling of the user at different times of skipping is more easily realized.

(12) The information recording and reproducing device of the present invention has an aspect, in the above (7), where the skipping process is divided into a plurality of sections, and the interval section is set for every section. According to such aspect, an easier realization of the control closer to the feeling of the user at different times of skipping can be easily achieved with a configuration different from the above described.

According to the present invention, the user can carry out reproduction while automatically skipping the location which the user desires to skip read without particularly performing the editing task in the subsequent information reproduction after performing the skipping process once.

The skipping section list is provided apart from the reproducing section list, and the skipping section is registered and updated in the skipping section list, and thus the user can easily check the skipping section deleted from the reproducing section list.

The information recording and reproducing device of the present invention is useful in enhancing the convenience of the reproduction task and the editing task in the skipping process.

### BRIEF DESCRIPTION OF THE DRAWINGS

Other objects of the present invention will be clear by understanding embodiments as will be described below and specified in the appended claims. Implementation of the present invention reminds the person in the art of many advantages which are not described in this specification.

FIG. 1 is a block diagram showing a configuration of a DVD recorder serving as a representative example of a randomly accessible information recording and reproducing device in the embodiments of the present invention;

FIGS. 2A and 2B are views describing various modes of a relative position relationship between the starting point/ending point of the skipping section and the starting point/ending point of the reproducing section in a first embodiment of the present invention (example 1);

FIGS. 3A and 3B are views describing various modes of a relative position relationship between the starting point/ending point of the skipping section and the starting point/ending point of the reproducing section in the first embodiment of the present invention (example 2);

FIG. 4 is an explanatory view of an operation example of the DVD recorder according to the first embodiment of the present invention;

FIG. 5 is an explanatory view of an operation example of the DVD recorder according to a second embodiment of the present invention;

FIGS. 6A and 6B are views describing various modes of a relative position relationship between the starting point/ending point of the skipping section and the starting point/ending point of the reproducing section in a third embodiment of the present invention (example 1);

FIGS. 7A and 7B are views describing various modes of a relative position relationship between the starting point/ending point of the skipping section and the starting point/ending point of the reproducing section in the third embodiment of the present invention (example 2);

FIG. 8 is an explanatory view of an operation example of the DVD recorder according to the third embodiment of the present invention;

FIG. 9 is an explanatory view of an operation example of the DVD recorder according to a fourth embodiment of the present invention;

FIG. 10 is a characteristic diagram showing a relationship between a constant time skipping amount and a criterion of a continuous skipping process in the second embodiment of the present invention (example 1);

FIG. 11 is a characteristic diagram showing a relationship between a constant time skipping amount and a criterion of a continuous skipping process in the second embodiment of the present invention (example 2);

FIG. 12 is a characteristic diagram showing a relationship between a constant time skipping amount and a criterion of a continuous skipping process in the second embodiment of the present invention (example 3);

FIG. 13 is a characteristic diagram showing a relationship between a constant time skipping amount and a criterion of a continuous skipping process in the second embodiment of the present invention (example 4);

FIG. 14 is a characteristic diagram showing a relationship between a constant time skipping amount and a criterion of a continuous skipping process in the second embodiment of the present invention (example 5);

FIG. 15 is a characteristic diagram showing a relationship between a constant time skipping amount and a criterion of a continuous skipping process in the second embodiment of the present invention (example 6);

FIG. 16 is a characteristic diagram showing a relationship between a constant time skipping amount and a criterion of a continuous skipping process in the second embodiment of the present invention (example 7); and

FIG. 17 is a characteristic diagram showing a relationship between a constant time skipping amount and a criterion of a continuous skipping process in the second embodiment of the present invention (example 8).

### DETAILED DESCRIPTION OF THE INVENTION

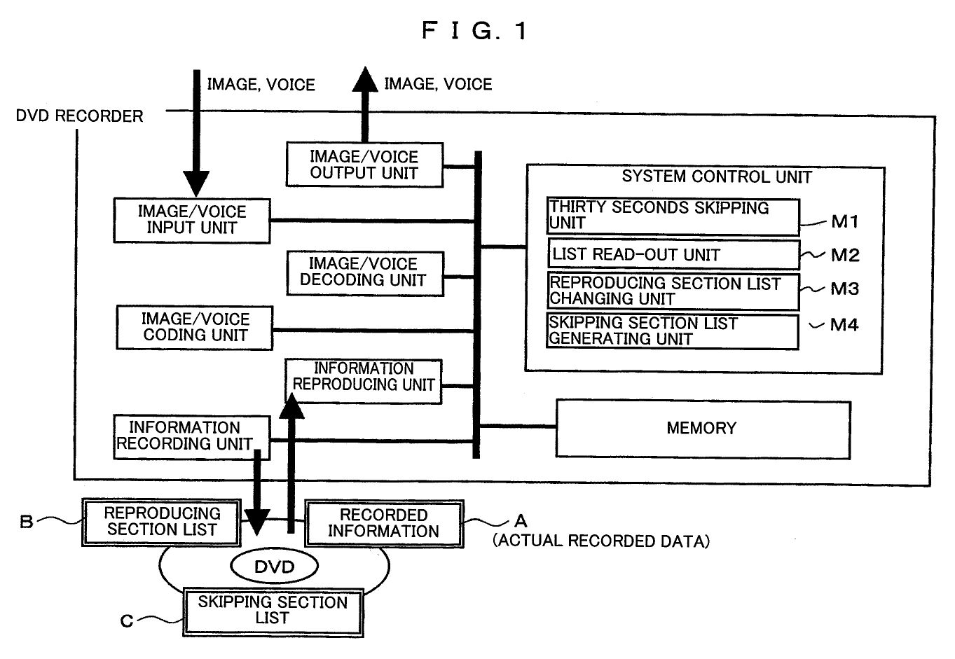

The embodiment of the information recording and reproducing device according to the present invention will be described in detail based on the drawings. FIG. 1 is a block diagram showing a configuration of a DVD recorder, which is one example of a randomly accessible information recording and reproducing device common in each embodiment of the present invention.

The DVD recorder includes a thirty seconds skipping unit M1, a list read-out unit M2, a reproducing section list changing unit M3, and a skipping section list generating unit M4. The thirty seconds skipping unit M1 is a processing unit for performing the process of skipping (skip reading process) the read-out position of information (image, voice) from the DVD (Digital Versatile Disc) over each period including a predetermined period (thirty seconds), and is one example of a skipping unit. The list read-out unit M2 reads out a reproducing section list B and a skipping section list C from the information of the DVD reproduced by an information reproducing unit. The reproducing section list changing unit M3 deletes the skipping section from the reproducing section after changing the reproducing section using a skip starting point Ss and a skip ending point Se in the reproducing section list read out by the list read-out unit M2 every time the thirty seconds skipping is performed by the thirty seconds skipping unit M1 during the reproduction of image from the DVD. The thirty seconds skipping unit M1 is an example of a skipping unit. The skipping section list generating unit M4 generates a skipping section list C using the skip starting point Ss and the skip ending point Se in the skipping section list C read out by the list read-out unit M2, creates a new skipping section list C if the skipping section list C is not present, and registers the skipping section deleted from the reproducing section to the created skipping section list C. The reproducing section list B and the skipping section list C created in this manner are recorded on the DVD (recording medium) by an information recording unit.

In the above configuration, a reproducing section list generator is configured by the information reproducing unit, the list read-out unit M2, the reproducing section list changing unit M3, and the information recording unit; and the skipping section list generator is configured by the information reproducing unit, the list read-out unit M2, the skipping section list generating unit M4, and the information recording unit. The reproducing section list B and the skipping section list C may be recorded in a memory of the information recording and reproducing device.

### FIRST EMBODIMENT

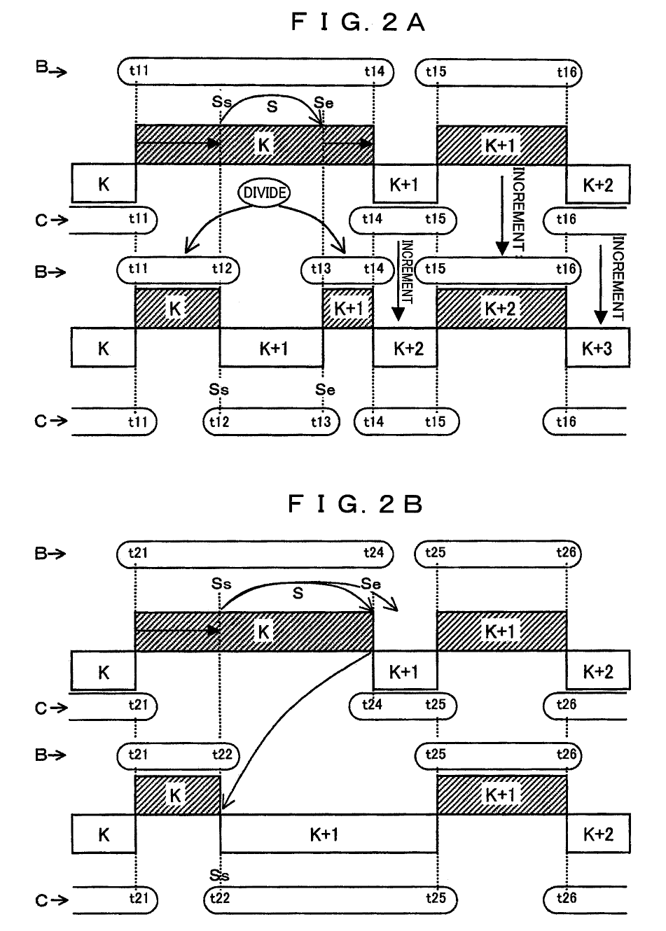

The information recording and reproducing device of the first embodiment of the present invention will be described with reference to FIGS. 2 to 4. The DVD recorder of the above configuration performs a search on whether all of or a part of the sections where the thirty seconds skipping is performed is contained in the reproducing section list B every time the thirty seconds skipping is performed during the image reproduction.

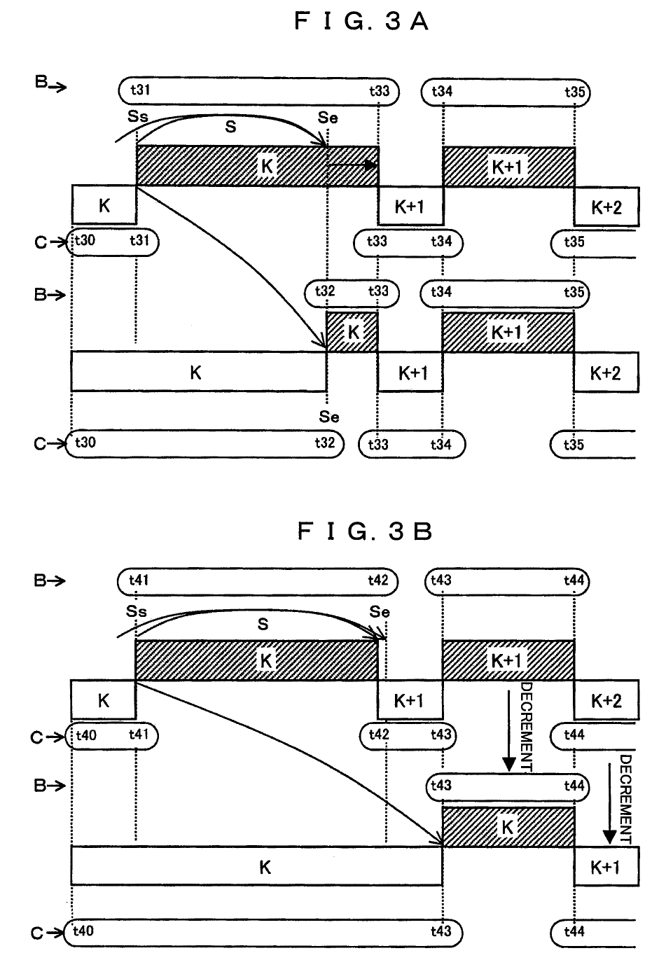

First, various relative position relationships between the skip starting point Ss/skip ending point Se in the skipping process S, and the starting point/ending point of the reproducing section K in the reproducing process will be described based on FIGS. 2A, 2B, 3A, and 3B.

(State of FIG. 2A)

In the state of FIG. 2A, the reproducing section K is divided in half, and this state corresponds to a state in which both the skip starting point Ss and the skip ending point Se are within the range of the reproducing section K in the reproducing section list B. Specifically, the state of FIG. 2A is defined as a state in which
the skip starting point Ss is at a position different from the starting point of the reproducing section K; and
the skip ending point Se is at a position different from the ending point of the reproducing section K. A new reproducing section can be added to the reproducing section list B.

In such state, the old reproducing section K needs to be updated in order to prohibit the reproduction corresponding to the skipping process S. That is, the corresponding portion of the skipping process S in the old reproducing section K needs to be deleted.

The reproducing section list changing unit M3 increments a reproducing section number by one from the old reproducing section (K+1) onward. In this case, the reproducing section list changing unit M3 performs the process of, in the reproducing section list B,
considering the old reproducing section (K+1) as a new reproducing section (K+2);
considering the old reproducing section (K+2) as a new reproducing section (K+3);
having the starting point of the new reproducing section K remaining as the starting point of the old reproducing section K; and
resetting the ending point of the new reproducing section K to the skip starting point Ss (data point: t12).

The reproducing section list changing unit M3 then newly creates the new reproducing section (K+1).

Furthermore, the reproducing section list changing unit M3 performs the process of,
setting the starting point of the new reproducing section (K+1) to the skip ending point Se (data point: t13); and
setting the ending point of the new reproducing section (K+1) to the ending point of the old reproducing section K.

In the reproducing section list B, the data that was at (t11, t14) in the old reproducing section K is updated to (t11, t12) in the new reproducing section K, and is registered as (t13, t14) in the new reproducing section (K+1). The data does not change and the skipping section number is merely incremented from the new reproducing section (K+2) onward.

The skipping section list generating unit M4 considers, in the skipping section list C,
the old skipping section (K+1) as the new skipping section (K+2); and
the old skipping section (K+2) as the new skipping section (K+3).

That is, the skipping section list generating unit M4 increments the skipping section number by one from the old skipping section (K+1) onward.

The skipping section list generating unit M4 newly creates and registers the new skipping section (K+1) having the starting point as the skip starting point Ss and the ending point as the skip ending point Se for the skipping section number (K+1) that becomes a vacant number as a result of performing the above process. Therefore, in the skipping section list C, (t12, t13) is newly registered as a new skipping section (K+1). The data does not change and the skipping section number is merely incremented from the new skipping section (K+2) onward. If the skipping section list C does not exist, a new skipping section list C is created, and the above skipping section is registered using the skip starting point Ss and the skip ending point Se.

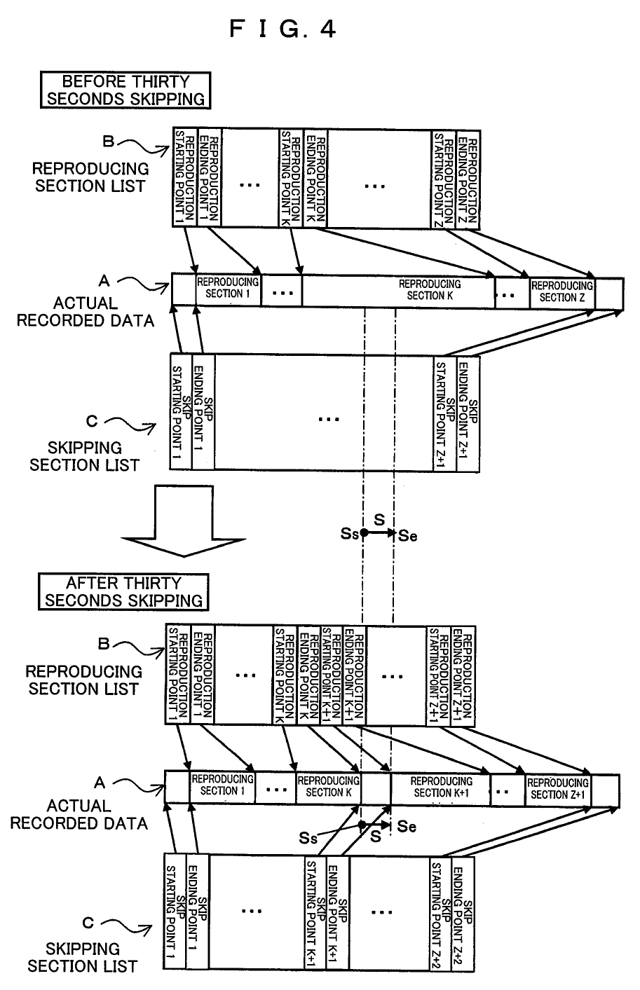

FIG. 4 shows the state of FIG. 2A in detail. The reproducing section list B is represented with columns of a data pair of the starting point and the ending point for each reproducing section. Similarly, the skipping section list C is represented with columns of a data pair of the starting point and the ending point for each skipping section. The actual recorded data A is continuous data from the starting point to the ending point for each reproducing section.

The actual recorded data A has,
the old reproducing section K divided to a new reproducing section K and a new reproducing section (K+1) with the skipping process S in between;
the ending point of the new reproducing section K reset to the skip starting point Ss in the reproducing section list B;
the starting point of the new reproducing section (K+1) reset to the skip ending point Se; and
the ending point of the new reproducing section (K+1) reset to the ending point of the old reproducing section K.

A new reproducing section can be added to the reproducing section list B in the description of the state of FIG. 2A, but the above processes are not performed if the new reproducing section cannot be added to the reproducing section list B.

(State of FIG. 2B)

In the state of FIG. 2B, the first half of the reproducing section K is still remaining, and this state corresponds to a state in which the skip starting point Ss is in the middle of the reproducing section K and the skip ending point Se is at the ending point or a position temporally beyond the ending point of the reproducing section K. In this state, the reproducing section list changing unit M3 resets the ending point of the new reproducing section K to the skip starting point Ss (data point: t22) in the reproducing section list B. Specifically, the data of the reproducing section list B that was at (t21, t24) in the old reproducing section K is updated to (t21, t22) in the new reproducing section K.

The skipping section list generating unit M4 resets the starting point of the new skipping section (K+1) to the skip starting point Ss in the skipping section list C. Specifically, the data of the skipping section list C that was at (t24, t25) in the old reproducing section K is updated to (t22, t25) in the new reproducing section (K+1). The process in the case where the skipping section list C does not exist is the same as described above.

In the state of FIG. 3A, the last half of the reproducing section K is remaining, and this state corresponds to a state in which
the skip starting point Ss coincides with the starting point of the reproducing section K or is positioned temporally before the starting point; and
the skip ending point Se is positioned in the middle of the reproducing section K.

In this state, the reproducing section list changing unit M3 resets the starting point of the new reproducing section K to the skip ending point Se (data point: t32) in the reproducing section list B. Specifically, the data of the reproducing section list B that was at (t31, t33) in the old reproducing section K is updated to (t32, t33) in the new reproducing section K.

The skipping section list generating unit M4 resets the ending point of the new skipping section K to the skip ending point Se in the skipping section list C. Specifically, the data of the skipping section list C that was at (t30, t31) in the old reproducing section K is updated to (t30, t32) in the new reproducing section K. The process in the case where the skipping section list C does not exist is the same as described above.

(State of FIG. 3B)

In the state of FIG. 3B, the entire reproducing section K is deleted, and this state corresponds to a state in which the skip starting point Ss coincides with the starting point of the reproducing section K or is positioned temporally before the starting point; and the skip ending point Se coincides with the ending point of the reproducing section K or is positioned temporally beyond the ending point. In this state, the reproducing section list changing unit M3 performs the process of, in the reproducing section list B,
deleting the reproducing section K;
considering the old reproducing section (K+1) as a new reproducing section K; and
considering the old reproducing section (K+2) as a new reproducing section (K+1).

That is, the reproducing section list changing unit M3 decrements a reproducing section number by one from the old reproducing section (K+1) onward.

The data of the reproducing section list B that was at (t41, t42) in the old reproducing section K is erased. The data does not change and the skipping section number is merely decremented from the new reproducing section K onward.

The skipping section list generating unit M4, in the skipping section list C,
treats the section from the starting point of the old skipping section K to the starting point of the old skipping section (K+1) collectively as a new skipping section K;
consider the old skipping section (K+1) as the new skipping section K; and
consider the old skipping section (K+2) as a new skipping section (K+1).

That is, the skipping section number is decremented by one from the old skipping section (K+1) onward.

The data of the skipping section list C that was at (t40, t41) in the old skipping section K is updated to (t40, t43) in the new skipping section K. The data does not change and the skipping section number is merely incremented from the new skipping section K onward.

No process is performed if the reproducing section K containing one part of the skipping process S does not exist. The user can select, at the time of reproduction, whether to carry out reproduction of all the actual recorded data or to carry out reproduction based on the automatically created reproducing section list B by not performing the process in the case where the reproducing section K containing one part of the skipping process S exists.

According to the present embodiment, if the constant time skipping process S is performed during the reproduction of information, the reproducing section is updated including the deletion of the skipping process S in the reproducing section list B, and the skipping section is updated in the skipping section list C. Thus, the user can carry out reproduction while automatically skipping the location where the user wants to skip read without performing any particular editing task in the subsequent reproduction of information. Furthermore, the user can easily check the skipping section deleted from the reproducing section list B since the skipping section list C is provided apart from the reproducing section list B and the skipping section is updated in the skipping section list C.

### SECOND EMBODIMENT

In the present embodiment, in the case where the constant time skipping process is performed during the reproduction of information, and the constant time skipping process is again subsequently performed, if a time interval (hereinafter referred to as sandwiched section) between the preceding constant time skipping process of a first time in the pair of constant time skipping processes and the following constant time skipping process of the second time is within a predetermined interval section T0, the process is performed collectively considering the two constant time skipping processes as a continuous skipping process. That is, the process is performed with three sections of the constant time skipping section of the first time, the constant time skipping section of the second time, and the sandwiched section as one skipping section (combined skipping section).

Information existing in the sandwiched section from the skip ending point Se of the first time to the skip starting point Ss of the second time can be considered as information the user normally does not want to reproduce. It is an aspect of the second embodiment to treat the sandwiched section as a target of deletion from the reproducing section list and a target of registration to the skipping section list.

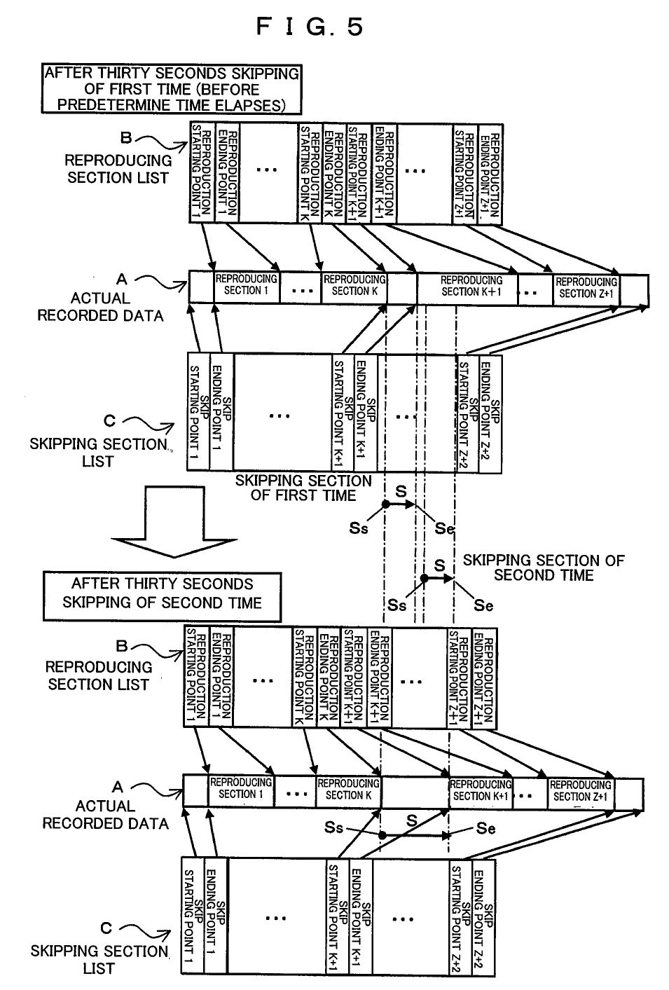

An information recording and reproducing device according to the second embodiment of the present invention will now be described with reference to FIG. 5. The DVD recorder of the present embodiment performs a search on whether all of or a part of the section from the skip ending point Se of the first time to the skip ending point Se of the second time is contained in the reproducing section list B in the case where the thirty seconds skipping is performed during the image reproduction and the thirty seconds skipping is continuously performed within the interval section T0.

As shown in FIG. 5, a state is considered in which
the skip ending point Se of the first time coincides with the starting point of a certain reproducing section (K+1) in the reproducing section list B; and
the skip ending point Se of the second time is positioned in the middle of the reproducing section (K+1).

In such state, the reproducing section list changing unit M3 deletes a range from the starting point to the skip ending point Se of the second time in the old reproducing section (K+1) of the reproducing section list B. That is, the starting point of the new reproducing section (K+1) is shifted backwards to the skip ending point Se of the second time. The skipping section list generating unit M4 resets the ending point of the new skipping section (K+1) to the skip ending point Se of the second time in the skipping section list C. The same applies to the case where the skip ending point Se of the first time is temporally before the starting point of a certain reproducing section (K+1) in the reproducing section list B.

A state is considered in which,
the skip ending point Se of the first time is contained in the reproducing section (K+1); and
the skip ending point Se of the second time coincides with the ending point of the reproducing section (K+1) or is positioned temporally behind the ending point.

Since the continuous skipping process S covers the entire old reproducing section (K+1) in such state, the reproducing section list changing unit M3,
deletes the old reproducing section (K+1) in the reproducing section list B; and
decrements the reproducing section number by one from the old reproducing section (K+2) onward.

The skipping section list generating unit M4, in the skipping section list C,
deletes the old skipping section (K+2);
decrements the skipping section number by one from the old skipping section (K+3) onward; and
shifts the ending point of the new skipping section (K+1) backwards to the starting point (skip ending point Se of the second time) of the new reproducing section (K+1).

The same applies to the case where the skip ending point Se of the first time is temporally before the starting point of a certain reproducing section (K+1) in the reproducing section list B. No process is performed if the section from the skip ending point Se of the first time to the skip ending point Se of the second time does not overlap with any reproducing section.

According to the present embodiment, the continuous skipping process can be dealt with as in the case of the first embodiment, whereby the trouble of the operation can be resolved, and the user can easily check the continuous skipping section.

### THIRD EMBODIMENT

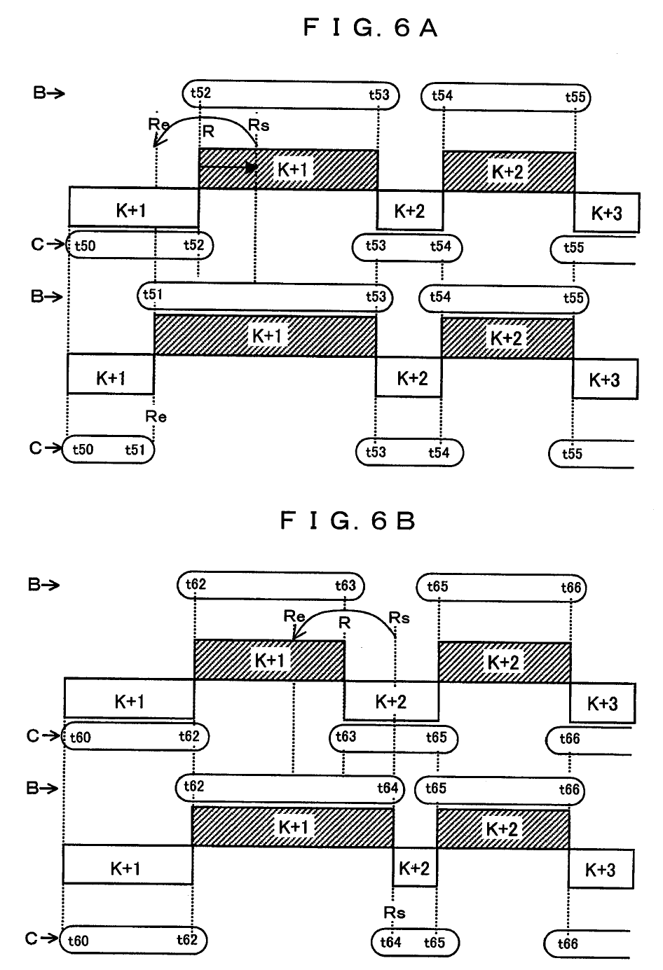

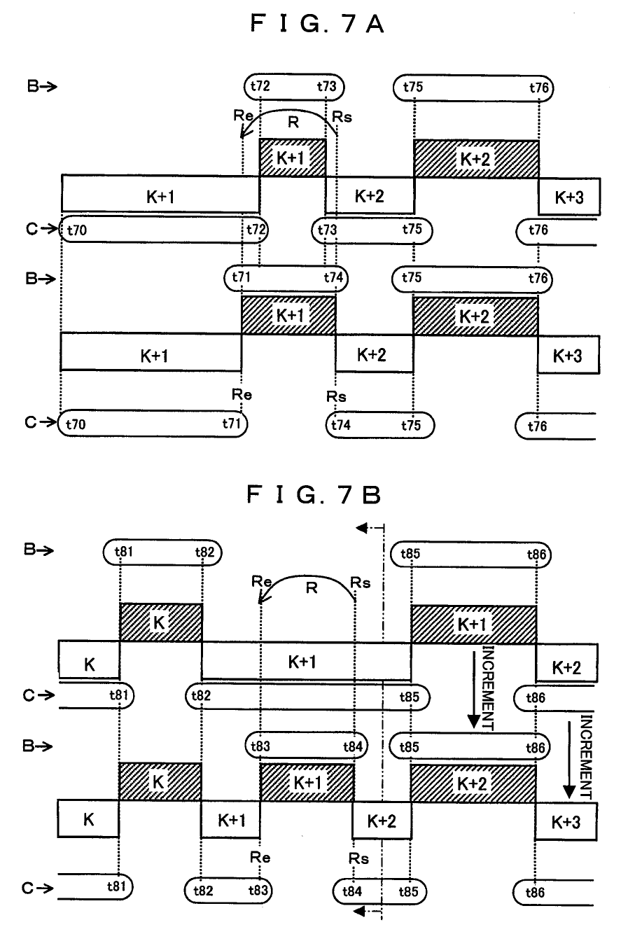

An information recording and reproducing device according to the third embodiment of the present invention will be described with reference to FIGS. 6 and 7. In the DVD recorder of the present embodiment, the thirty seconds skipping unit M1 also has a function of performing the thirty seconds skipping in an opposite direction. When the thirty seconds skipping in the opposite direction is performed during the image reproduction, the DVD recorder specifies the skip starting point Rs in the opposite direction and the skip ending point Re in the opposite direction, and then performs a search on whether all of or apart of the opposite-direction skipping process R is contained in the reproducing section list B. In the opposite-direction skipping process R, an opposite-direction skip ending point Re is on the upstream side of the opposite-direction skip starting point Rs in a forward direction, and is in a converse relation with the case of normal skipping process (in the normal skipping process, the skip ending point is on the downstream side of the skip starting point). Therefore, the process of the present embodiment is not performed in a state in which,
the opposite-direction skip starting point Rs is contained in a certain reproducing section (K+1) of the reproducing section list B; and
the opposite-direction skip ending point Re exists in the reproducing section (K+1).

(State of FIG. 6A)

The state of FIG. 6A is a state in which the reproducing section extends towards the front. This state corresponds to a state in which,
the opposite-direction skip starting point Rs is contained in a certain reproducing section (K+1) of the reproducing section list B; and
the opposite-direction skip ending point Re is not contained in the reproducing section (K+1).

In such state, the reproducing section list changing unit M3 resets the starting point of the new reproducing section (K+1) to the opposite-direction skip ending point Re (data point: t51) in the reproducing section list B. Specifically, the data of the reproducing section list B that was at (t52, t53) in the old reproducing section (K+1) is updated to (t51, t53) in the new reproducing section (K+1).

The skipping section list generating unit M4 resets the ending point of the new skipping section (K+1) to the opposite-direction skip ending point Re in the skipping section list C. Specifically, the data of the skipping section list C that was at (t50, t52) in the old skipping section (K+1) is updated to (t50, t51) in the new skipping section (K+1).

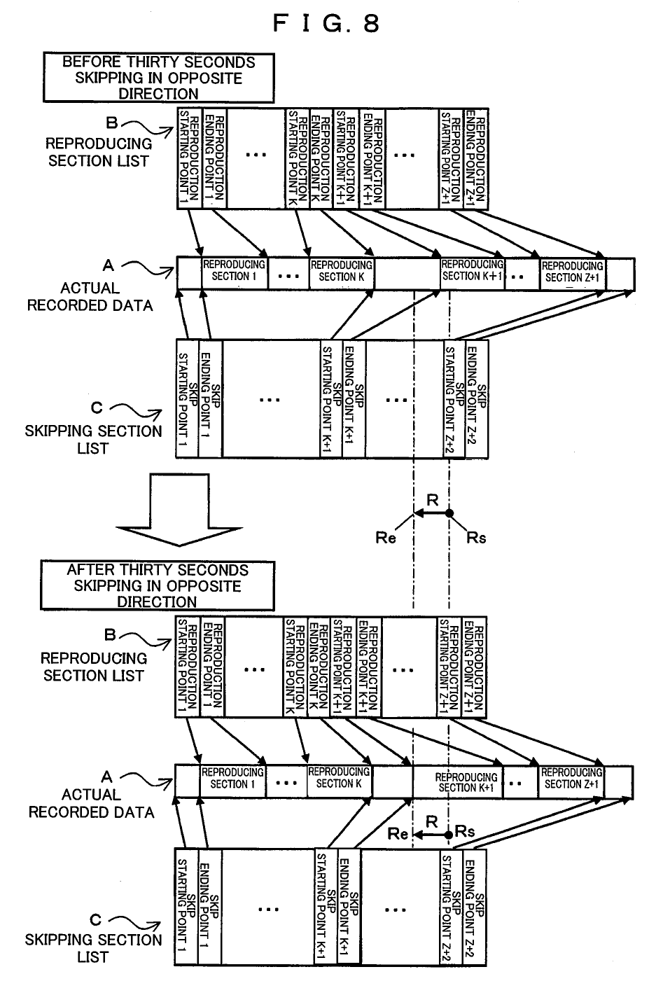

FIG. 8 shows the state of FIG. 6A in detail. The reproducing section list B is represented with columns of a data pair of the starting point and the ending point for each reproducing section. Similarly, the skipping section list C is represented with columns of a data pair of the starting point and the ending point for each skipping section. The actual recorded data A is continuous data from the starting point to the ending point in each reproducing section. In the actual recorded data A, the old reproducing section (K+1) is extended towards the front in response to the opposite-direction skipping process R. The starting point of the new reproducing section (K+1) is reset to the opposite-direction skip ending point Re, and the ending point of the new skipping section (K+1) is reset to the opposite-direction skip ending point Re.

(State of FIG. 6B)

The state of FIG. 6B is a state in which the reproducing section extends towards the back. This state corresponds to a state in which, the opposite-direction skip starting point Rs is not contained in the reproducing section (K+1), but the opposite-direction skip ending point Re exists in the middle of the reproducing section (K+1). In such state, the reproducing section list changing unit M3 resets the ending point of the reproducing section (K+1) to the opposite-direction skip starting point Rs (data point: t64) in the reproducing section list B. Specifically, the data of the reproducing section list B that was at (t62, t63) in the old reproducing section (K+1) is updated to (t62, t64) in the new reproducing section (K+1).

The skipping section list generating unit M4 resets the starting point of the new skipping section (K+2) to the opposite-direction skip starting point Rs in the skipping section list C. Specifically, the data of the skipping section list C that was at (t63, t65) in the old reproducing section (K+2) is updated to (t64, t65) in the new reproducing section (K+2).

(State of FIG. 7A)

The state of FIG. 7A is a state in which the reproducing section is expanded towards the front and the back. One part of the opposite-direction skipping process R overlaps with a certain reproducing section (K+1) in the reproducing section list B. However, neither the opposite-direction skip starting point Rs nor the opposite-direction skip ending point Re is contained in the reproducing section (K+1). In such case, the reproducing section list changing unit M3 resets the starting point of the reproducing section (K+1) to the opposite-direction skip ending point Re (data point: t71), and resets the ending point of the reproducing section (K+1) to the opposite-direction skip starting point Rs (data point: t74). Specifically, the data of the reproducing section list B that was at (t72, t73) in the old reproducing section (K+1) is updated to (t71, t74) in the new reproducing section (K+1).

The skipping section list generating unit M4 resets the ending point of the new skipping section (K+1) to the opposite-direction skip ending point Re, and resets the starting point of the new skipping section (K+2) to the opposite-direction skip starting point Rs in the skipping section list C. Specifically, the data of the skipping section list C that was at (t70, t72) in the old skipping section (K+1) is updated to (t70, t71) in the new skipping section (K+1). Furthermore, the data of the skipping section list C that was at (t73, t75) in the old skipping section (K+2) is updated to (t74, t75) in the new skipping section (K+2).

(State of FIG. 7B)

The state of FIG. 7B is a state in which a new skipping section is added at a skipping location. In this state,
a reproducing section containing one part of the opposite-direction skipping process R does not exist in the reproducing section list B;
a new reproducing section can be added to the reproducing section list B; and
reproducing section (K+1) exists from the opposite-direction skip starting point Rs onward.

In such state, the reproducing section list changing unit M3 increments the reproducing section number by one from the old reproducing section (K+1) onward in the reproducing section list B. The reproducing section list changing unit M3 makes, in the additional reproducing section (K+1), the starting point thereof the opposite-direction skip ending point Re (data point: t83), and makes the ending point thereof the opposite-direction skip starting point Rs (data point: t84). The data of the reproducing section list B at the new reproducing section (K+1) is registered to (t83, t84).

Furthermore, the skipping section list generating unit M4 is, in the skipping section list C, in a state in which
a new skipping section is addable; and
skipping section exists from the opposite-direction skip starting point Rs onward.

In such state, the skipping section list generating unit M4 increments the reproducing section number by one from the old skipping section (K+2) onward. Furthermore, the skipping section list generating unit M4,
resets the ending point of the new skipping section (K+1) to the opposite-direction skip ending point Re;
sets the starting point of the new skipping section (K+2) to the opposite-direction skip starting point Rs; and
sets the ending point to the ending point of the old skipping section (K+1).

As a result, the data of the skipping section list C that was at (t82, t85) in the old skipping section (K+1) is updated to (t82, t83) in the new skipping section (K+1), and registered to (t84, t85) in the new skipping section (K+2).

In the case where the reproducing section does not exist from the opposite-direction skip starting point Rs onward, the process needs to be considered only for the region in a direction of the chain dashed arrow in FIG. 7B. The above processes do not need to be executed in the case where a new reproducing section cannot be added to the reproducing section list B.

According to the present embodiment, reproduction of information can be carried out without subsequently automatically skipping the location which the user actually desires to reproduce by performing the opposite-direction skipping process. Furthermore, the user can easily check even the skipping section from the opposite-direction skipping onwared.

### FOURTH EMBODIMENT

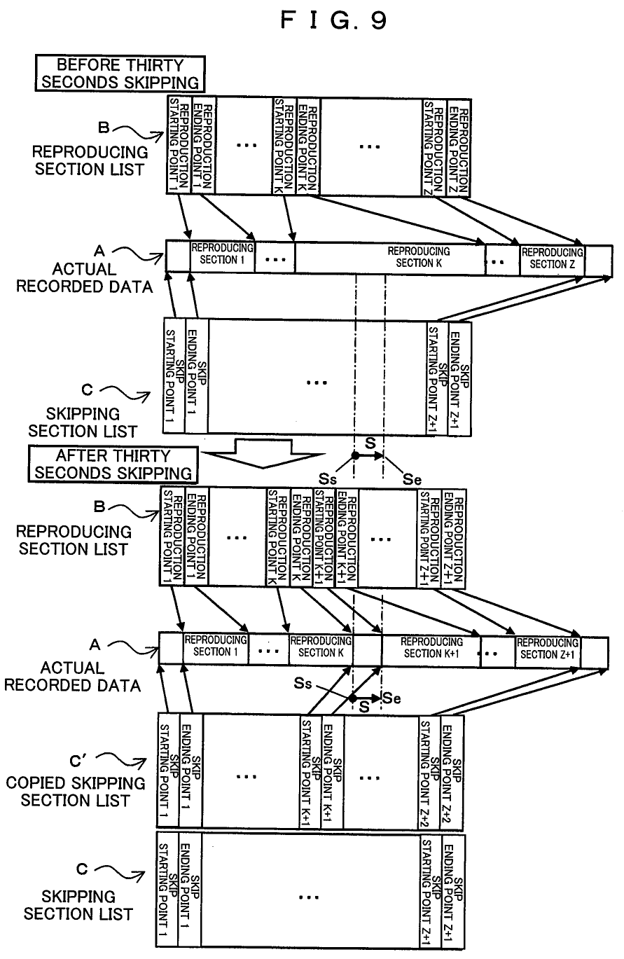

An information recording and reproducing device according to the fourth embodiment of the present invention will be described with reference to FIG. 9. In the DVD recorder of the present embodiment, determination is made on,
whether or not a new reproducing section is addable to the reproducing section list B; or
whether or not a new skipping section is addable to the skipping section list C, every time a thirty seconds skipping process is performed during reproduction of an image.

If both determinations are negative, the above processes are not performed. However, if at least one of the determinations is positive, the reproducing section list B and the skipping section list C are copied and the above processes are performed on the copied reproducing section list B and the skipping section list C instead of making changes directly on the lists.

In the second embodiment, an inherent process of the second embodiment is performed in the case where the constant time skipping process is performed and the constant time skipping process is thereafter again performed within the interval section T0 during the image reproduction. The interval section T0 will be described below in further detail. The interval section T0 takes various modes as described below.

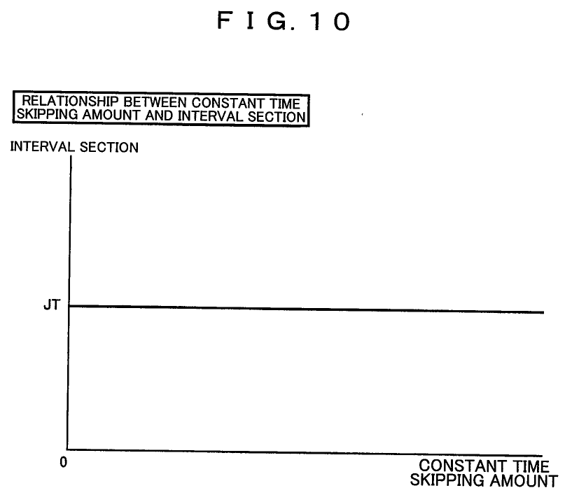

(1) In the example shown in FIG. 10, the interval section T0 is constantly set to a fixed value (e.g., JT) regardless of the change in size of the constant time skipping amount. This interval section T0 is stored in an internal register. When the time interval (sandwiched interval) between the constant time skipping process of the first time and the constant time skipping process of the second time is within the interval section T0, the reproducing section list changing unit M3 and the skipping section list generating unit M4 execute the process of the second embodiment. That is,
consider the section from the constant time skipping starting point Ss of the first time to the constant time skipping ending point Se of the second time as one skipping process (continuous skipping process);
delete the section of the two skipping processes from the reproducing section list B and register the same in the skipping section list C; and
delete the section from the constant time skipping ending point Se of the first time to the constant time skipping starting point Ss of the second time from the recorded information and register the same in the skipping section list C.

The realization of the function is more facilitated by handling the interval section T0 as a fixed value irrespective of the change in size of the constant time skipping amount.

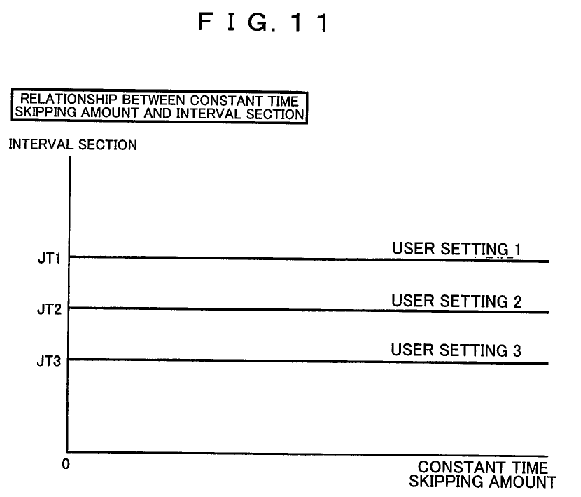

(2) As shown in FIG. 11, the interval section t0 is constantly set to a fixed value regardless of the change in size of the constant time skipping amount, similar to the (1), but the value can be changed by the user (e.g., JT1, JT2, JT3). That is, the interval section T0 is arbitrarily customized by the user. The control suited to the feeling of each user becomes possible by constantly handling the interval section T0 at the fixed value specified by the user.

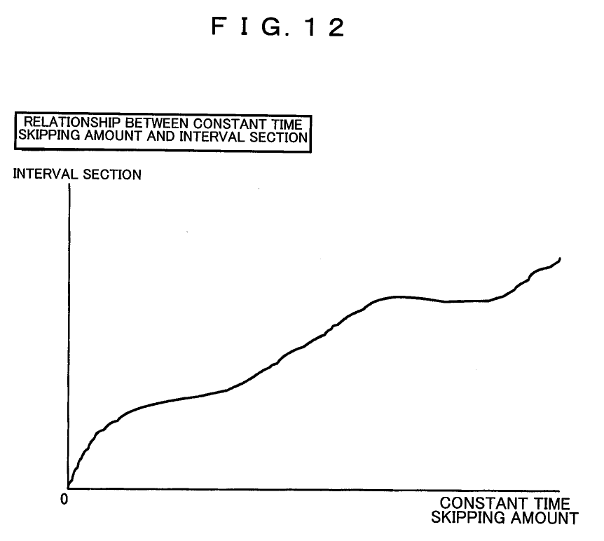

(3) As shown in FIG. 12, the interval section T0 is calculated from the skipping amount using a conversion function and a conversion table internally held by the DVD recorder. That is, the interval section T0 is determined dependent on the constant time skipping amount. Accordingly, the control closer to the feeling of the user at different times of skipping becomes possible.

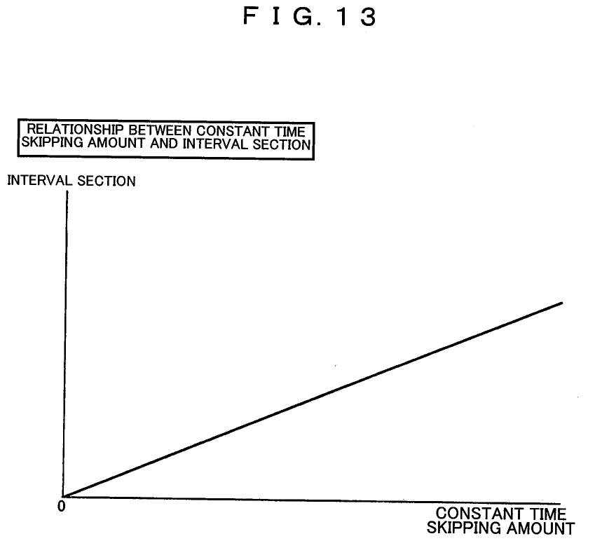

(4) As shown in FIG. 13, the interval section T0 is calculated from the constant time skipping amount using a linear function internally held by the DVD recorder. Accordingly, the control closer to the feeling at different times of skipping is more easily realized.

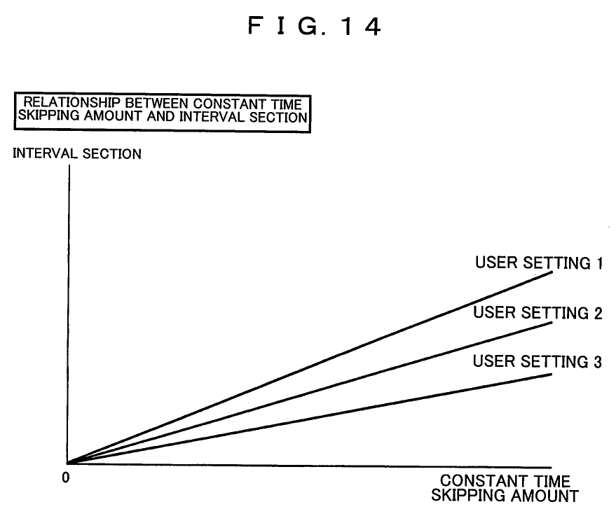

(5) As shown in FIG. 14, the interval section T0 is calculated using the linear function, similar to (4), but the slope or the Y intercept of the linear function can be changed by the user. The interval section T0 is calculated with the linear function from the constant time skipping amount, and the slope or the Y intercept of the linear function is customized by the user. Accordingly, the control closer to the feeling of the user who has carried out skipping is more easily realized.

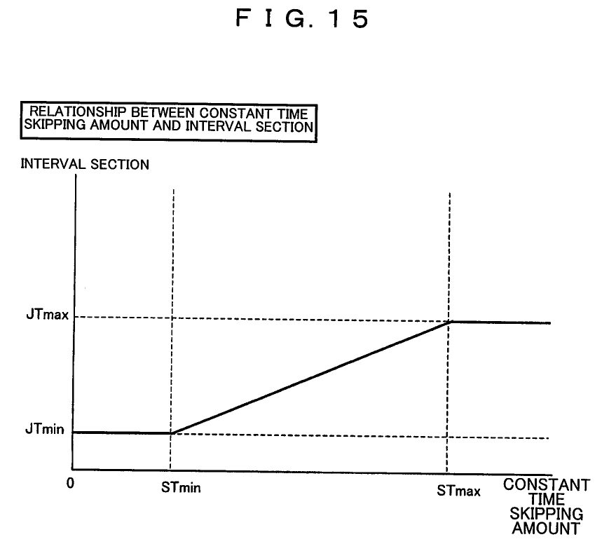

(6) As shown in FIG. 15, if the constant skipping amount ST is greater than or equal to a lower limit value (STmin) and less than an upper limit value (STmax) (Stmin≦ST<STmax), the interval section T0 is calculated from the constant time skipping amount using the linear function. The interval section T0 takes a fixed lower limit threshold value (JTmin) when the skipping amount is less than the lower limit value (STmin) and a fixed upper limit threshold value (JTmax) when the skipping amount is greater than or equal to the upper limit value (STmax). The lower limit value, the upper limit value, the lower limit threshold value, and the upper limit threshold value can be changed by the user. That is, the interval section T0 is determined dependent on the constant time skipping amount, but a lower limit and an upper limit are respectively given. Accordingly, it is avoidable by providing an upper limit that a next constant skipping process after performing an extremely long constant skipping process is determined as continuous despite the fact that the next constant skipping process is actually irrelevant to the extremely long constant skipping process. The constant time skipping process immediately after performing an extremely short constant time skipping process can be determined as continuous as intended by the user by providing a lower limit.

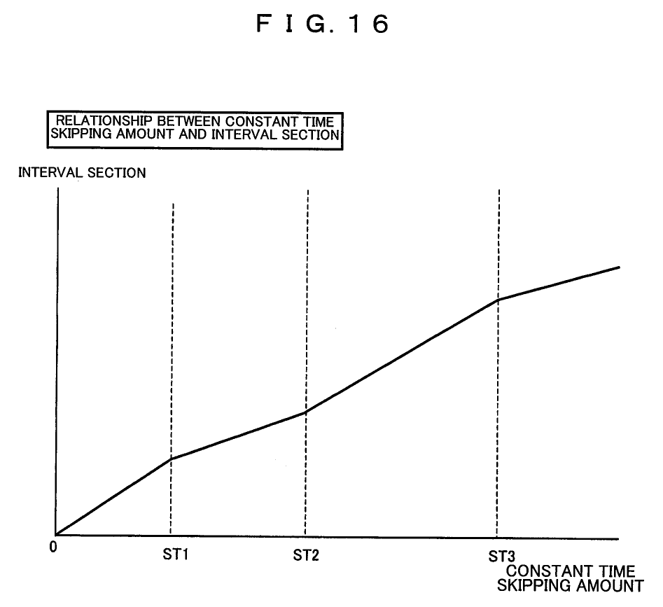

(7) As shown in FIG. 16, the interval section T0 is calculated from the constant time skipping amount using the linear function, but the skipping amount is divided into a plurality of ranges, and a linear function used to calculate the threshold value thereof is held for every range. The slope or the Y intercept of each linear function can be changed by the user. Accordingly, the control closer to the feeling of the user at different times of skipping is more easily realized.

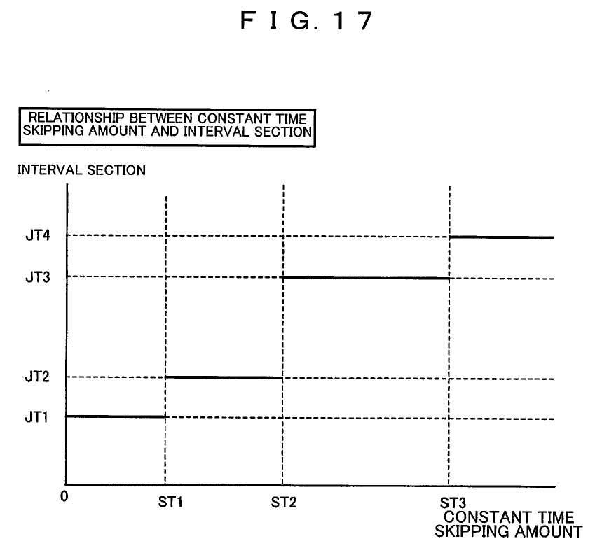

(8) As shown in FIG. 17, the interval section T0 is calculated from the constant time skipping amount using the table internally held by the DVD recorder, but the skipping amount is divided into a plurality of ranges, and a threshold value is held for every range. Each threshold value can be changed by the user. Accordingly, an easier realization of a control closer to the feeling of the user at different times of skipping process can be achieved with a part different from the above.

Although the embodiments of the present invention have been described in the above, various combinations and arrangements of the components in the preferred embodiment can be made without departing from the spirit and scope of the present invention as will be claimed below.

What is claimed is:

1. An information recording and reproducing device comprising:
a skipping unit for performing a skipping process of skip reading information when reading out and reproducing the information from a recording medium;
a reproducing section list generator for generating and recording a reproducing section list, which is a section list of a reproduction process of reading out and reproducing the information; and
a skipping section list generator for generating and recording a skipping section list, which is a section list of the skipping process in which the skipping unit skip reads the information over a period greater than or equal to a predetermined period when reading out the information; wherein
the reproducing section list generator deletes a skipping section from the reproducing section every time the skipping unit performs the skipping process over a period greater than or equal to the predetermined period; and
the skipping section list generator creates a skipping section list including the skipping section deleted from the reproducing section list.

2. The information recording and reproducing device according to claim 1, wherein when a continuous skipping process in which a pair of skipping processes adjacent on a time axis is continuously performed within a predetermined interval section,
the reproducing section list generator deletes the combined skipping section from the starting point of the preceding process to the ending point of the following process of the pair of skipping processes from the reproducing section in the reproducing section list; and
the skipping section list generator creates the skipping section in the skipping section list including the combined skipping section.

3. The information recording and reproducing device according to claim 1, wherein when an opposite-direction skipping process is performed as the skipping process and an ending point of the opposite-direction skipping process is contained in the skipping section in the reproducing section list,
the reproducing section list generator includes an opposite-direction skipping section in the reproducing section in the reproducing section list; and
the skipping section list generator deletes the opposite-direction skipping section from the skipping section in the skipping section list.

4. The information recording and reproducing device according to claim 1, wherein the skipping section list generator copies the skipping section list, and changes either the original or the copy of the skipping section list.

5. The information recording and reproducing device according to claim 2, wherein the reproducing section list generator and the skipping section list generator set the interval section constant irrespective of change in length of the skipping section.

6. The information recording and reproducing device according to claim 5, wherein the reproducing section list generator and the skipping section list generator set a plurality of interval sections different from each other, each interval section being constant irrespective of a change in length of the skipping section; and
the reproducing section list generator and the skipping section list generator can set an arbitrary interval section selected from among the plurality of interval sections.

7. The information recording and reproducing device according to claim 2, wherein the reproducing section list generator and the skipping section list generator set an interval section having correlation with the skipping section as the interval section.

8. The information recording and reproducing device according to claim 7, wherein the interval section is a linear function of the skipping section.

9. The information recording and reproducing device according to claim 8, wherein a slope and a Y intercept of the linear function can be arbitrarily set.

10. The information recording and reproducing device according to claim 7, wherein the interval section is a linear function of the skipping section, and has a lower limit value and an upper limit value.

11. The information recording and reproducing device according to claim 7, wherein the interval section is a linear function of the skipping section, and a slope and a Y intercept of the linear function vary according to the skipping section.

12. The information recording and reproducing device according to claim 7, wherein the skipping section is divided into a plurality of sections, and the interval section is set for every section.
